(19) United States
(12) Patent Application Publication
(10) Pub. No.: US 2016/0377780 A1
(43) Pub. Date: Dec. 29, 2016

(54) OPTICAL REFLECTION FILM

(71) Applicant: KONICA MINOLTA, INC., Tokyo (JP)

(72) Inventor: Makoto HONDA, Machida-shi, Tokyo (JP)

(21) Appl. No.: 15/038,860

(22) PCT Filed: Dec. 19, 2014
(86) PCT No.: PCT/JP2014/083768

§ 371 Date: May 24, 2016

(30) Foreign Application Priority Data
Dec. 27, 2013 (JP) 2013-271418

(51) Int. Cl. G02B 5/30; G02B 1/14; B60J 3/00; G02B 5/08

(52) U.S. Cl. CPC G02B 5/3083; G02B 5/0841; G02B 1/14; B60J 3/007

(57) ABSTRACT

An object of the present invention is to provide an optical reflection film which is suppressed in iridescent irregularities caused by unevenness of birefringence or film thickness among layers of a reflection unit and has excellent optical reflection performance and light transmittance.

The optical reflection film of the present invention, having a plurality of function layers includes at least: a reflection unit that is obtained by alternately laminating a high-refractive-index layer and a low-refractive-index layer and reflects light; and a birefringence layer that has an in-plane retardation of 3000 nm or more.

### TECHNICAL FIELD

The present invention relates to an optical reflection film.

### BACKGROUND ART

In general, a reflection unit that selectively reflects light with a specific wavelength by adjusting the respective optical film thicknesses of high-refractive-index layers and low-refractive-index layers and alternately laminating the layers, is utilized as an optical reflection film that selectively reflects near-infrared rays, ultraviolet rays, and the like. Such an optical reflection film is used as a heat-ray shielding film to be pasted, for example, on buildings or vehicles.

However, optical anisotropy occurs in the lamination structure due to unevenness of birefringence or film thickness (layer thickness) of respective layers constituting the reflection unit of such an optical reflection film, and thus iridescent light interference color which is expressed on the surface of the optical reflection film by light interference (hereinafter, referred to as iridescent irregularities) may occur.

It is considered that the unevenness of film thickness (layer thickness) of respective layers constituting the reflection unit is caused by unevenness of molecular distribution, smoothness of the surface, distortion or deformation of the layer generated in the producing step, or the like.

As a method for suppressing iridescent irregularities, Patent Literature 1 describes a method in which alight scattering layer is provided on a base film in a polarizer protective film using a film as a base material, and the overall haze value (%) of the polarizer protective film is set to 40 to 60 so as to suppress occurrence of iridescent irregularities due to transmitted light caused by birefringence of the base film.

In addition, Patent Literature 2 describes a method in which, regarding iridescent irregularities caused by interference of reflection light of an interface between respective layers in an optical laminated film obtained by sequentially laminating a first easy adhesive layer, a second easy adhesive layer, and a surface layer on a support, occurrence of iridescent irregularities is suppressed by controlling a refractive index and a film thickness (layer thickness) of each layer of the lamination structure.

However, according to the method of Patent Literature 1, iridescent irregularities are reduced, but since the haze value is as high as 40 to 60, a problem arises in which light transmittance is low. Further, in the case of an optical reflection film which reflects light with a specific wavelength by a reflection unit obtained by alternately laminating a high-refractive-index layer and a low-refractive-index layer, if the refractive index and film thickness (layer thickness) of each layer are adjusted, optical reflection performance is adversely affected. Therefore, according to the method of Patent Literature 2 in which iridescent irregularities are suppressed by controlling the refractive index and the film thickness (layer thickness), optical reflection performance is deteriorated.

### CITATION LIST

### Patent Literature

Patent Literature 1: JP 2012-212122 A
Patent Literature 2: JP 2008-209877 A

### SUMMARY OF INVENTION

### Technical Problem

In this regard, an object of the present invention is to provide an optical reflection film which is suppressed in iridescent irregularities caused by unevenness of birefringence or film thickness among layers of a reflection unit and has excellent optical reflection performance and light transmittance.

### Solution to Problem

The above object of the present invention is achieved by the following configurations.

1. An optical reflection film having a plurality of function layers, including at least: a reflection unit that is obtained by alternately laminating a high-refractive-index layer and a low-refractive-index layer and reflects light; and a birefringence layer that has an in-plane retardation of 3000 nm or more.

2. The optical reflection film according to the above 1, wherein the birefringence layer is disposed between an outermost layer and the reflection unit of the optical reflection film.

3. The optical reflection film according to the above 1 or 2, wherein two or more reflection units are provided, and the birefringence layer is disposed between the outermost layer and the reflection unit that is the closest to the outermost layer.

4. The optical reflection film according to any one of the above 1 to 3, wherein two or more reflection units are provided, and the birefringence layer is disposed between two reflection units.

5. The optical reflection film according to any one of the above 1 to 4, wherein the birefringence layer is disposed to come into contact with at least one surface of the reflection unit.

6. The optical reflection film according to any one of the above 1 to 5, wherein the birefringence layer is disposed on at least one surface of the reflection unit with an adhesive layer interposed therebetween.

7. An optical reflection film being pasted on an indoor side of a window glass of a building, including: a reflection unit that is obtained by alternately laminating a high-refractive-index layer and a low-refractive-index layer and reflects light; and a birefringence layer that has an in-plane retardation of 3000 nm or more, wherein the birefringence layer is disposed between the reflection unit and an outermost layer opposite to a surface, which faces the window glass, of the optical reflection film.

8. An optical reflection film being pasted on a vehicle interior side of a window glass of a vehicle, including: a reflection unit that is obtained by alternately laminating a high-refractive-index layer and a low-refractive-index layer and reflects light; and a birefringence layer that has an in-plane retardation of 3000 nm or more, wherein the birefringence layer is disposed between the reflection unit and an outermost layer, which comes into contact with the window glass, of the optical reflection film.

The outermost layer described herein indicates a layer disposed on the outermost layer of the lamination structure of the optical reflection film regardless of the light incident direction.

### Advantageous Effects of Invention

According to the present invention, when the birefringence layer having an in-plane retardation of 3000 nm or more is provided in the optical reflection film including the reflection unit which is obtained by laminating the high-refractive-index layer and the low-refractive-index layer, it is possible to provide an optical reflection film which is suppressed in iridescent irregularities caused by unevenness of birefringence or film thickness among layers of the reflection unit and has excellent optical reflection performance and light transmittance.

When the birefringence layer having an in-plane retardation of 3000 nm or more is provided in the optical reflection film in which iridescent irregularities occur due to unevenness of birefringence or film thickness of the reflection unit, the wavelength peak of interference light generated by the reflection unit is dispersed, and thus occurrence of iridescent irregularities is suppressed.

### BRIEF DESCRIPTION OF DRAWINGS

FIG. 1A is a schematic cross-sectional view illustrating an example of the configuration of an optical reflection film.

FIG. 1B is a schematic cross-sectional view illustrating an example of the configuration of the optical reflection film.

FIG. 2A is a schematic cross-sectional view illustrating an example of the layer configuration of the optical reflection film.

FIG. 2B is a schematic cross-sectional view illustrating an example of the layer configuration of the optical reflection film.

FIG. 2C is a schematic cross-sectional view illustrating an example of the layer configuration of the optical reflection film.

FIG. 2D is a schematic cross-sectional view illustrating an example of the layer configuration of the optical reflection film.

FIG. 3A is a schematic cross-sectional view illustrating an example of the layer configuration of the optical reflection film and an observation direction.

FIG. 3B is a schematic cross-sectional view illustrating an example of the layer configuration of the optical reflection film and an observation direction.

FIG. 3C is a schematic cross-sectional view illustrating an example of the layer configuration of the optical reflection film and an observation direction.

### DESCRIPTION OF EMBODIMENTS

Hereinafter, modes for carrying out the present invention will be described. However, the present invention is not limited to embodiments to be described below, and can be carried out by arbitrarily modifying the embodiments within a scope not departing from the gist of the present invention. Incidentally, in the following description, the same configurations are denoted by the same reference numbers, and the duplicated description thereof will be omitted.

<<Configuration of Optical Reflection Film>>

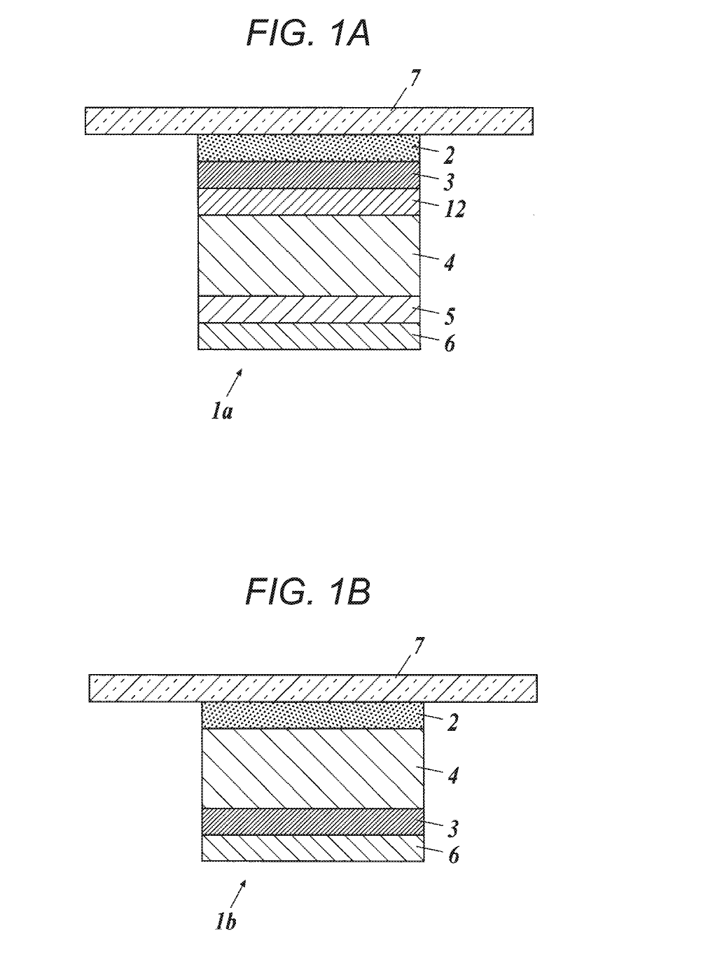

Hereinafter, the configuration of an optical reflection film of the present invention will be described by means of FIG. 1A and FIG. 1B.

FIG. 1A is a schematic cross-sectional view illustrating a state where an optical reflection film 1a according to an embodiment of the present invention is pasted on a substrate 7. The optical reflection film 1a of FIG. 1A has a lamination structure, a reflection unit 4 is laminated on one surface of a base material 5, and a hard coat layer 6 is laminated on the other surface. A birefringence layer 3 is pasted on a surface opposite to the surface, which comes into contact with the base material 5, of the reflection unit 4 with an adhesive layer 12 interposed therebetween. A pressure-sensitive adhesive layer 2 is laminated on a surface opposite to the surface, which corresponds to the reflection unit 4, of the birefringence layer. That is, the optical reflection film 1a is configured to include the pressure-sensitive adhesive layer 2, the birefringence layer 3, the adhesive layer 12, the reflection unit 4, the base material 5, and the hard coat layer 6. Further, the optical reflection film 1a is pasted on the substrate 7 by the pressure-sensitive adhesive layer 2. The reflection unit 4 is formed by alternately laminating high-refractive-index layers and low-refractive-index layers and has nine reflection layers in total. The birefringence layer 3 has an in-plane retardation of 3000 nm or more.

In FIG. 1A and FIG. 1B, the pressure-sensitive adhesive layer 2 and the hard coat layer 6 are disposed on the outermost layers of the optical reflection films 1a and 1b, and the birefringence layer 3 is disposed between the outermost layer and the reflection unit 4.

When the birefringence layer 3 is disposed at the outer layer in relation to the reflection unit 4, the wavelength peak of interference light generated by unevenness of birefringence or film thickness of respective layers constituting the reflection unit 4 is dispersed by the birefringence layer 3, and thus occurrence of iridescent irregularities is suppressed.

The interference light generated by the birefringence layer is considered to be generated not only in the transmission direction of light incident to the optical reflection film but also in the reflection direction. Therefore, when the birefringence layer is disposed at the outer layer in relation to the reflection unit regardless of the incident direction of light with respect to the optical reflection film, the interference light generated in the optical reflection film is dispersed by the birefringence layer, and thus light with reduced wavelength peak can be extracted. Accordingly, it is considered that a high effect of suppressing iridescent irregularities is achieved.

In the optical reflection film 1a of FIG. 1A, the birefringence layer 3 and the reflection unit 4 are pasted to each other with the adhesive layer 12 interposed therebetween by a lamination method. On the other hand, FIG. 1B illustrates an example in which the reflection unit 4 is formed directly on the birefringence layer 3. In other words, the hard coat layer 6 is provided on one surface of the birefringence layer 3 of the optical reflection film 1b in FIG. 1B and the reflection unit 4 is formed directly on the other surface of the birefringence layer 3 by a coating method. The pressure-sensitive adhesive layer 2 is laminated on the surface opposite to the surface, which comes into contact with the birefringence layer 3, of the reflection unit 4, and the pressure-sensitive adhesive layer 2, the reflection unit 4, the birefringence layer 3, and the hard coat layer 6 constitute the optical reflection film 1b. Further, the optical reflection film 1b is pasted on the substrate 7 by the pressure-sensitive adhesive layer 2.

From the viewpoint of productivity of the optical reflection film, the reflection unit is preferably formed by a coating method. In a case where the reflection unit is formed directly on the birefringence layer, a base material may not be provided in the optical reflection unit, and thus suppression of production cost can be achieved in addition to high productivity. On the other hand, in a case where the reflection unit is formed by coating on the base material and the birefringence layer is laminated with an adhesive interposed therebetween, an optical reflection film with excellent mechanical strength can be obtained.

In the optical reflection film, when the outer layer in relation to the reflection unit or the birefringence layer is provided, the reflection unit or the birefringence layer can be protected. When a function layer is disposed on the outermost layer of the optical reflection film, a function corresponding to the function layer can be provided. For example, as illustrated in FIG. 1A and FIG. 1B, when the pressure-sensitive adhesive layer 2 is disposed on the outermost layer of the optical reflection film, the optical reflection film 1 can be pasted on the indoor side (vehicle interior side or room interior side) or the outdoor side of the substrate 7 such as glass windows of vehicles or buildings. Further, when the hard coat layer 6 is disposed on the outermost layer of the optical reflection film, damages on the surface of the optical reflection film can be prevented.

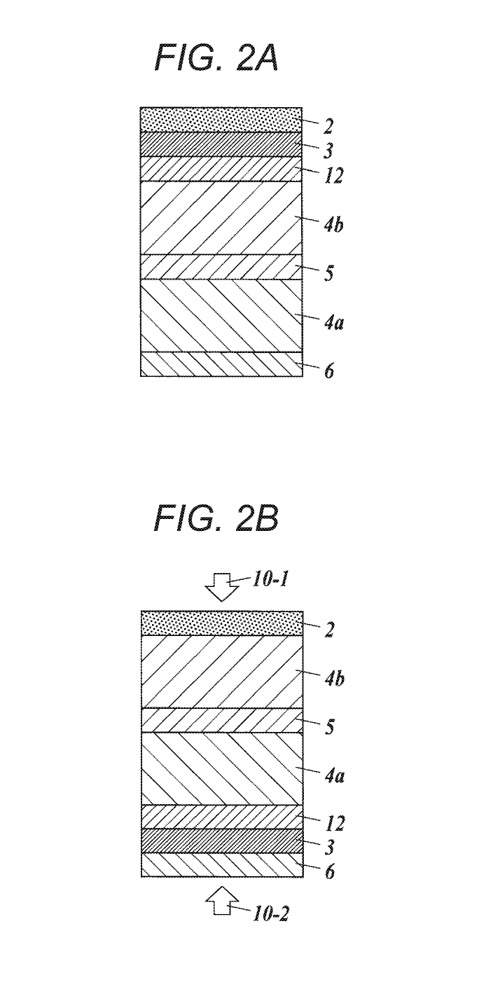

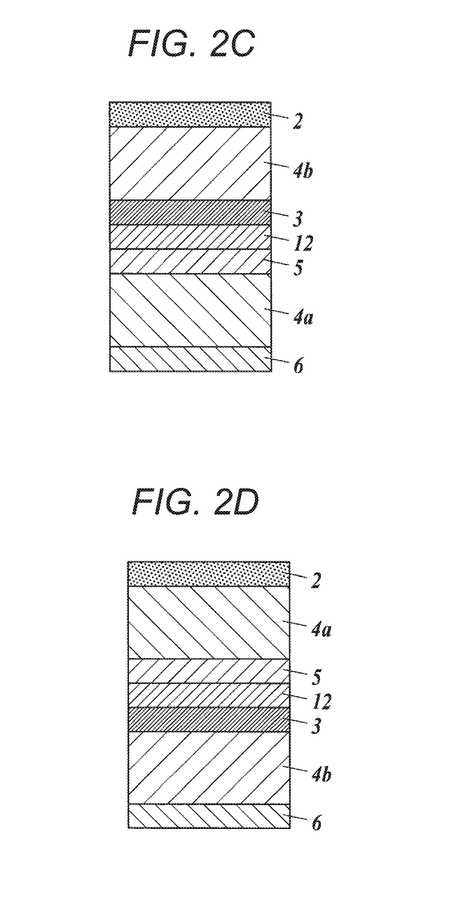

FIGS. 2A to 2D are schematic cross-sectional views illustrating another example of the layer configuration of the optical reflection film. In the optical reflection film of the present invention, the number of layers of the reflection unit and the birefringence layer is not particularly limited as long as the optical reflection film has a layer configuration capable of achieving optical reflection performance and light transmittance.

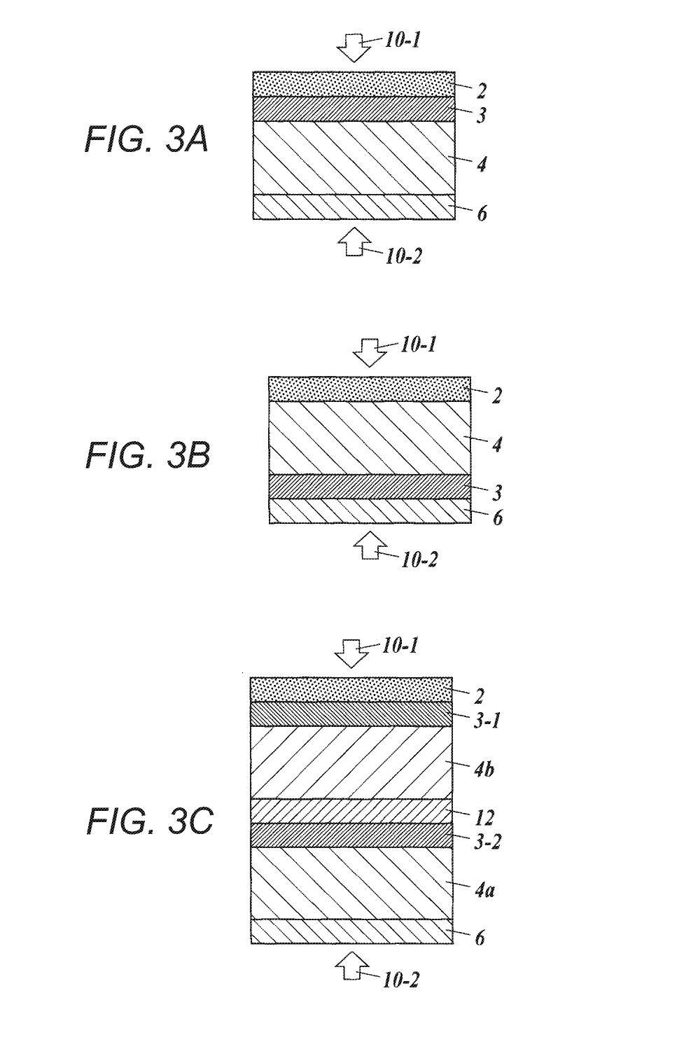

In a case where a plurality of the reflection units or the birefringence layers are provided, as illustrated in FIGS. 2A to 2D or FIG. 3C, the birefringence layer may be disposed at the outer layer in relation to at least one reflection unit or the birefringence layer may be disposed between two reflection units as illustrated in FIG. 2C and FIG. 2D.

In the configuration of FIG. 2C in which the birefringence layer 3 is disposed between a reflection unit 4b and a reflection unit 4a, when light is incident from the pressure-sensitive adhesive layer 2 side, the wavelength peak of interference light in the transmission direction generated by the reflection unit 4b and the wavelength peak of interference light in the reflection direction generated by the reflection unit 4a are dispersed by the birefringence layer 3, and thus occurrence of iridescent irregularities is suppressed.

From the viewpoint of suppressing iridescent irregularities by dispersing the wavelength peak of interference light caused by unevenness of birefringence or film thickness of each layer constituting the reflection unit, it is preferable to dispose the birefringence layer at the outer layer (a side at which iridescent irregularities are checked) in relation to the reflection unit that is disposed closest to the side at which iridescent irregularities of the optical reflection film are checked.

<<Method for Producing Optical Reflection Film>>

Hereinafter, the method for producing the optical reflection film of the present invention will be described in more detail.

Incidentally, hereinafter, when the low-refractive-index layer and the high-refractive-index layer are not distinguished from each other, the low-refractive-index layer and the high-refractive-index layer are referred to as “refractive index layer” as a concept including the two. Further, in the present specification, the expression “X to Y” representing a range indicates “equal to or higher than X but equal to or lower than Y.” Furthermore, unless otherwise specified, an operation and measurement for physical properties or the like are performed under the conditions of room temperature (20 to 25° C.)/relative humidity of 40 to 50%.

<Birefringence Layer>

The birefringence layer in the present invention is a polymer film having an in-plane retardation of 3000 nm or more and birefringence properties, and the in-plane retardation can be controlled by appropriately setting the stretching ratio, the stretching temperature, and the film thickness in the stretching process of the polymer material.

The polymer material is not particularly limited, and as examples thereof, polyester such as polyethylene terephthalate or polyethylene naphthalate, polycarbonate, polystyrene, polyether ether ketone, polyphenylene sulfide, a cycloolefin polymer, and the like, which have excellent transparency, thermal characteristics, and mechanical characteristics, are used. Two or more kinds of the polymers material described above may be included.

The surface of the polymer film may be subjected to surface treatment or adhesion facilitating treatment by a known method for the purpose of improving water resistance, chemical resistance, and adhesiveness between the polymer film and a layer formed on the polymer film, such as the reflection unit, the hard coat layer, or the pressure-sensitive adhesive layer. The adhesion facilitating treatment can be performed by using various known methods. For example, a method may suitably be employed of applying one of various known adhesion facilitating agents to the film during the production process thereof or to the film that has been uniaxially or biaxially stretched.

The production method and the thickness of the polymer film are not particularly limited as long as the film characteristics are satisfied.

Incidentally, the in-plane retardation in the present invention is obtained by means of the following Equation (1), and can also be obtained by measuring the refractive indices in two axis directions and the thickness or can also be obtained by using an automatic birefringence measurement apparatus, such as KOBRA-21ADH (Oji Scientific Instruments Co., Ltd.), which is commercially available.

In-plane retardation [nm]=(nx−ny)×d Equation (1):

In the equation, nx represents the in-plane refractive index of the optical reflection film in the slow axis direction (the maximum in-plane refractive index), ny represents the in-plane refractive index of the optical reflection film in the direction perpendicular to the slow axis, nz represents the refractive index of the film in the thickness direction thereof, and d represents the thickness (nm) of the optical reflection film.

Incidentally, in the present invention, the in-plane retardation was measured by using an automatic birefringence analyzer KOBRA-21ADH (manufactured by Oji Scientific Instruments Co., Ltd.). Under the environment of 23° C. and 55% RH, three-dimensional birefringence index measurement was conducted in a wavelength of 550 nm at an interval of 1 cm in the width direction of a sample, and the measured value was substituted into Equation (1) to obtain an in-plane retardation.

<Reflection Unit>

(Layer Structure of Reflection Unit)

The reflection unit in the present invention has a lamination structure in which at least two or more layers of the low-refractive-index layer or the high-refractive-index layer. A suitable form of the reflection unit is a form of an alternating laminated body in which a low-refractive-index layer and a high-refractive-index layer are alternately laminated. Incidentally, in the present specification, a refractive index layer having a higher refractive index compared with the other refractive index layer is referred to as a high-refractive-index layer and a refractive index layer having a lower refractive index compared with the other refractive index layer is referred to as a low-refractive-index layer. In the present specification, the terms “high-refractive-index layer” and “low-refractive-index layer” mean that, when a difference between refractive indices of two adjacent layers is compared, a refractive index layer having a higher refractive index is designated as the high-refractive-index layer and a refractive index layer having a lower refractive index is designated as the low-refractive-index layer. Thus, the terms “high-refractive-index layer” and “low-refractive-index layer” include all forms other than the form in which, when attention is paid to two adjacent refractive index layers for each refractive index layer that constitutes the reflection unit, the respective refractive index layers have the same refractive index.

The reflection unit includes two layers each having a different refractive index, that is, at least one lamination structure consisted of the high-refractive-index layer and the low-refractive-index layer; however, the high-refractive-index layer and the low-refractive-index layer are contemplated to be as follows.

For example, there is a case where a component constituting the high-refractive-index layer (hereinafter, referred to as the high-refractive-index layer component) and a component constituting the low-refractive-index layer (hereinafter, referred to as the low-refractive-index layer component) are mixed at an interface between two layers, and thus a layer containing the high-refractive-index layer component and the low-refractive-index layer component (mixed layer) is formed. In this case, in the mixed layer, a collection of sites containing 50% by mass or more of the high-refractive-index layer component is designated as the high-refractive-index layer, and a collection of sites containing more than 50% by mass of the low-refractive-index layer component is designated as the low-refractive-index layer. Specifically, for example, in a case where the low-refractive-index layer contains a first metal oxide as the low-refractive-index component and the high-refractive-index layer contains a second metal oxide as the high-refractive-index component, the metal oxide concentration profile in the film thickness direction in such a reflection unit is measured, and the high-refractive-index layer or the low-refractive-index layer can be determined based on the composition thereof. The metal oxide concentration profile of the reflection unit can be monitored by performing etching from the surface in the depth direction using a sputtering method, performing sputtering at a rate of 0.5 nm/min using an XPS surface analyzer, with the outermost surface being defined as 0 nm, and measuring the atomic composition ratio. Further, in a reflection unit in which the low-refractive-index component or the high-refractive-index component does not include any metal oxide but is formed only from an organic binder, for example, the carbon concentration in the film thickness direction is measured similarly from the organic binder concentration profile, and thereby it is confirmed that a mixed region exists. The composition thereof is then analyzed by EDX, and thereby each of the layers that have been etched by sputtering can be determined as the high-refractive-index layer or the low-refractive-index layer.

Regarding an XPS surface analyzer, any type of an instrument can be used without particular limitation. However, ESCALAB-200R manufactured by VG Scientifics Co., Ltd. was used. Mg is used as an X ray anode and the measurement is carried out at an output of 600 W (an acceleration voltage of 15 kV and an emission electric current of 40 mA).

In general, it is preferable for the reflection unit to design the difference between the refractive indices of the low-refractive-index layer and the high-refractive-index layer to be large, from the viewpoint that higher optical reflectance can be obtained with a smaller number of layers. For at least one reflection unit composed of a low-refractive-index layer and a high-refractive-index layer, the difference between the refractive indices of adjacent low-refractive-index layer and high-refractive-index layer is preferably 0.1 or more, more preferably 0.3 or more, even more preferably 0.35 or more, and particularly preferably more than 0.4. In a case where the optical reflection film has a plurality of reflection units, it is preferable that the difference in the refractive index between the high-refractive-index layer and the low-refractive-index layer in all of the reflection units is in the suitable range described above. However, in regard to the layer disposed at the outermost side of the reflection unit, configurations other than the suitable range may also be employed. Further, the refractive index of the low-refractive-index layer is preferably 1.10 to 1.60 and more preferably 1.30 to 1.50. In addition, the refractive index of the high-refractive-index layer is preferably 1.80 to 2.50 and more preferably 1.90 to 2.20.

The reflectance in a specific wavelength region is determined by the difference between the refractive indices of adjacent two layers and the number of lamination, and as the difference in the refractive index is larger, the same reflectance is obtained with a smaller number of layers. This difference in the refractive index and the required number of layers can be calculated using a commercially available optical design software program. For example, in order to obtain an infrared reflectance of 90% or more, if the difference in the refractive index is smaller than 0.1, lamination of 200 or more layers is needed. Thus, not only productivity is lowered, but also scattering at the lamination interfaces is increased, transparency is decreased, and it becomes very difficult to produce the optical reflection film without failure. From the viewpoint of enhancing the reflectance and reducing the number of layers, there is no upper limit on the difference in the refractive index, but the upper limit is substantially about 1.4.

Furthermore, regarding the optical characteristics of the reflection unit, the transmittance in the visible light region according to JIS R 3106-1998 is 50% or more, preferably 75% or more, and more preferably 85% or more. In addition, it is preferable that the reflection unit has a region with a reflectance of more than 50% in the wavelength range of 900 to 1400 nm.

From the viewpoint described above, the range of the total number of layers of the reflection unit is preferably 100 layers or less, more preferably 40 layers or less, and even more preferably 20 layers or less. Further, the reflection unit may have a configuration of laminating at least one layer of the high-refractive-index layer and the low-refractive-index layer, and for example, the reflection unit may have a lamination structure in which any of layers disposed at the outermost side of the reflection unit is the high-refractive-index layer or the refractive-index layer. For the optical reflection film of the present invention, a layer configuration in which layers disposed at the outermost side in the reflection unit are low-refractive-index layers is preferable.

The thickness per layer of the low-refractive-index layer is preferably 20 to 800 nm and more preferably 50 to 350 nm. On the other hand, the thickness per layer of the high-refractive-index layer is preferably 20 to 800 nm and more preferably 50 to 350 nm.

Regarding the material that forms the reflection unit, conventionally known materials can be used, and examples thereof include metal oxide particles, polymers, and combinations thereof. It is preferable that at least any one of the low-refractive-index layer and the high-refractive-index layer contains metal oxide particles, and it is more preferable that both of them contain metal oxide particles.

Examples of the metal oxide particles may include, as examples of the high-refractive-index material, titanium dioxide (TiO₂), zirconium dioxide (ZrO₂), and tantalum pentoxide (Ta₂O₅); and as examples of the low-refractive-index material, silicon dioxide (SiO₂) and magnesium fluoride (MgF₂). These metal oxide particles are dispersed in a polymer solution so that a film can be produced by coating.

There are no particular limitations on the polymer contained in the reflection unit, and any polymer capable of forming a reflection unit can be used without any particular limitations.

For example, the polymers described in JP 2002-509279 W can be used as the polymer. Specific examples thereof include polyethylene naphthalate (PEN) and isomers thereof (for example, 2,6-, 1,4-, 1,5-, 2,7-, and 2,3-PEN), polyalkylene terephthalates (for example, polyethylene terephthalate (PET), polybutylene terephthalate, and poly-1,4-cyclohexanedimethylene terephthalate), polyimides (for example, polyacrylamide), polyether imide, atactic polystyrene, polycarbonate, polymethacrylates (for example, polyisobutyl methacrylate, polypropyl methacrylate, polyethyl methacrylate, and polymethyl methacrylate (PMMA)), polyacrylates (for example, polybutyl acrylate and polymethyl acrylate), cellulose derivatives (for example, ethyl cellulose, acetyl cellulose, cellulose propionate, acetyl cellulose butyrate, and cellulose nitrate), polyalkylene polymers (for example, polyethylene, polypropylene, polybutylene, polyisobutylene, and poly(4-methyl)pentene), fluorinated polymers (for example, a perfluoroalkoxy resin, polytetrafluoroethylene, a fluorinated ethylene-propylene copolymer, polyvinylidene fluoride, and polychlorotrifluoroethylene), chlorinated polymers (for example, polyvinylidene chloride and polyvinyl chloride), polysulfone, polyether sulfone, polyacrylonitrile, polyamide, silicone resins, epoxy resins, polyvinyl acetate, polyether amide, ionomer resins, elastomers (for example, polybutadiene, polyisoprene, and neoprene), and polyurethane. Copolymers, for example, copolymers of PEN [for example, copolymers of (a) terephthalic acid or esters thereof, (b) isophthalic acid or esters thereof, (c) phthalic acid or esters thereof, (d) an alkane glycol, (e) a cycloalkane glycol (for example, cyclohexanedimethanol diol), (f) alkanedicarboxylic acid, and/or (g) cycloalkanedicarboxylic acid (for example, cyclohexanedicarboxylic acid), with 2,6-, 1,4-, 1,5-, 2,7-, and/or 2,3-naphthalenedicarboxylic acid or esters thereof], copolymers of polyalkylene terephthalates [for example, copolymers of (a) naphthalenedicarboxylic acid or esters thereof, (b) isophthalic acid or esters thereof, (c) phthalic acid or esters thereof, (d) an alkane glycol, (e) a cycloalkane glycol (for example, cyclohexanedimethanol diol), (f) alkanedicarboxylic acid, and/or (g) cycloalkanedicarboxylic acid (for example, cyclohexanedicarboxylic acid), with terephthalic acid or esters thereof], and styrene copolymers (for example, styrene-butadiene copolymers and styrene-acrylonitrile copolymers), 4,4-bisbenzoic acid, and ethylene glycol are also suitable. Further, the respective layers may contain a blend of two or more kinds of the polymers or copolymers described above (for example, a blend of syndiotactic polystyrene (SPS) and atactic polystyrene).

The reflection unit can be formed by subjecting the polymer described above to melt extrusion and stretching of polymer as described in U.S. Pat. No. 6,049,419. In the present invention, preferred combinations of the polymers that form the high-refractive-index layer and the low-refractive-index layer include PEN/PMMA, PEN/polyvinylidene fluoride, and PEN/PET.

Further, the polymers described in JP 2010-184493 A may also be used as the polymer. Specifically, a polyester (hereinafter, also referred to as polyester A) and a polyester containing residues derived from at least three kinds of diols such as ethylene glycol, spiroglycol, and butylene glycol (hereinafter, also referred to as polyester B) can be used. The polyester A is not particularly limited as long as it has a structure obtainable by polycondensing a dicarboxylic acid component and a diol component, and examples thereof include polyethylene terephthalate, polypropylene terephthalate, polybutylene terephthalate, polyethylene-2,6-naphthalate, poly-1, 4-cyclohexanedimethylene terephthalate, and polyethylene diphenylate. The polyester A may also be a copolymer. Herein, a copolymerized polyester has a structure obtainable by performing polycondensation using at least three or more kinds in total of dicarboxylic acid components and diol components. Examples of the dicarboxylic acid component include terephthalic acid, isophthalic acid, phthalic acid, 1,4-naphthalenedicarboxylic acid, 1,5-naphthalenedicarboxylic acid, 2,6-naphthalenedicarboxylic acid, 4,4′-diphenyldicarboxylic acid, 4,4′-diphenylsulfonedicarboxylic acid, adipic acid, sebacic acid, dimeric acid, cyclohexanedicarboxylic acid, and ester-forming derivatives thereof. Examples of the glycol component include ethylene glycol, 1,2-propanediol, 1,3-butanediol, 1,4-butanediol, 1,5-pentadiol, diethylene glycol, polyalkylene glycol, 2,2-bis(4′-β-hydroxyethoxyphenyl)propane, isosorbate, 1,4-cyclohexanedimethanol, spiroglycol, and ester-forming derivatives thereof. The polyester A is preferably polyethylene terephthalate or polyethylene naphthalate.

The polyester B contains residues derived from at least three kinds of diols such as ethylene glycol, spiroglycol, and butylene glycol. Typical examples thereof include a copolymerized polyester having a structure obtainable by performing copolymerization using ethylene glycol, spiroglycol, and butylene glycol and a polyester obtainable by blending polyesters having structures that are obtained by performing polymerization using the relevant three kinds of diols. With this configuration, molding processing can be easily achieved and delamination does not easily occur, which is preferable. Furthermore, it is preferable that the polyester B is a polyester containing residues derived from at least two kinds of dicarboxylic acids such as terephthalic acid/cyclohexanedicarboxylic acid. Such a polyester may be a copolyester obtained by copolymerizing terephthalic acid/cyclohexanedicarboxylic acid or a blend of a polyester containing terephthalic acid residues and a polyester containing cyclohexanedicarboxylic acid residues. A polyester containing cyclohexanedicarboxylic acid residues is such that the difference between the in-plane average refractive index of the A layer and the in-plane average refractive index of the B layer becomes large, and thus a product having a high reflectance is obtained. Further, since the difference in the glass transition temperature between such a polyester and polyethylene terephthalate or polyethylene naphthalate is small, there is less chance of over-stretching occurring at the time of molding and delamination does not easily occur, which is preferable.

In addition to that, it is also preferable to use a water-soluble polymer as the polymer. Since a water-soluble polymer does not use an organic solvent, there is less environmental burden, and since the water-soluble polymer is highly flexible, durability of the film at the time of bending is enhanced, which is preferable. Examples of the water-soluble polymer include polyvinyl alcohols, polyvinylpyrrolidones, acrylic resins such as polyacrylic acid, an acrylic acid-acrylonitrile copolymer, a potassium acrylate-acrylonitrile copolymer, a vinyl acetate-acrylic acid ester copolymer, or an acrylic acid-acrylic acid ester copolymer, styrene-acrylic acid resins such as a styrene-acrylic acid copolymer, a styrene-methacrylic acid copolymer, a styrene-methacrylic acid-acrylic acid ester copolymer, a styrene-α-methylstyrene-acrylic acid copolymer, or a styrene-α-methylstyrene-acrylic acid-acrylic acid ester copolymer, a styrene-sodium styrenesulfonate copolymer, a styrene-2-hydroxyethyl acrylate copolymer, a styrene-2-hydroxyethyl acrylate-potassium styrenesulfonate copolymer, a styrene-maleic acid copolymer, a styrene-maleic anhydride copolymer, a vinylnaphthalene-acrylic acid copolymer, a vinylnaphthalene-maleic acid copolymer, vinyl acetate-based copolymers such as a vinyl acetate-maleic acid ester copolymer, a vinyl acetate-crotonic acid copolymer, and a vinyl acetate-acrylic acid copolymer. Among these, particularly preferred examples include polyvinyl alcohol, polyvinylpyrrolidones, and copolymers containing these, from the viewpoint of handleability at the time of production and flexibility of the film. These water-soluble polymers may be used alone or in combination of two or more kinds thereof.

Examples of polyvinyl alcohol that is preferably used in the present invention include general polyvinyl alcohol that is obtained by hydrolyzing polyvinyl acetate, as well as modified polyvinyl alcohols. Examples of the modified polyvinyl alcohols include cationically modified polyvinyl alcohol, anionically modified polyvinyl alcohol, nonionically modified polyvinyl alcohol, and vinyl alcohol-based polymers.

Regarding the polyvinyl alcohol obtained by hydrolyzing vinyl acetate, a polyvinyl alcohol having an average degree of polymerization of 800 or more is preferably used, and a polyvinyl alcohol having an average degree of polymerization of 1,000 to 5,000 is particularly preferably used. Further, the degree of saponification is preferably 70 to 100% by mole and particularly preferably 80 to 99.5% by mole.

Examples of the cationically modified polyvinyl alcohol include a polyvinyl alcohol as described in JP 61-10483 A, which has primary to tertiary amino groups or quaternary ammonium groups in the main chain or side chains of the polyvinyl alcohol, and this is obtained by saponifying a copolymer of an ethylenically unsaturated monomer having a cationic group and vinyl acetate.

Examples of the ethylenically unsaturated monomer having a cationic group include trimethyl-(2-acrylamide-2,2-dimethylethyl) ammonium chloride, trimethyl-(3-acrylamide-3,3-dimethylpropyl) ammonium chloride, N-vinylimidazole, N-vinyl-2-methylimidazole, N-(3-dimethylaminopropyl) methacrylamide, hydroxyethyltrimethylammonium chloride, trimethyl-(2-methacrylamide propyl) ammonium chloride, and N-(1, 1-dimethyl-3-dimethylaminopropyl) acrylamide. The proportion of a cationically modified group-containing monomer in the cationically modified polyvinyl alcohol is preferably 0.1 to 10% by mole and more preferably 0.2 to 5% by mole with respect to vinyl acetate.

Examples of the anionically modified polyvinyl alcohol include a polyvinyl alcohol having an anionic group as described in JP 1-206088 A, copolymers of vinyl alcohol and vinyl compounds having water-soluble groups as described in JP 61-237681 A and JP 63-307979 A, and a modified polyvinyl alcohol having a water-soluble group as described in JP 7-285265 A.

Further, examples of the nonionically modified polyvinyl alcohol include a polyvinyl alcohol derivative obtained by adding a polyalkylene oxide group to a portion of vinyl alcohol as described in JP 7-9758 A, a block copolymer of a vinyl compound having a hydrophobic group and vinyl alcohol as described in JP 8-25795 A, silanol-modified polyvinyl alcohol having a silanol group, and reactive group-modified polyvinyl alcohol having a reactive group such as an acetoacetyl group, a carbonyl group, or a carboxy group. Further, examples of the vinyl alcohol-based polymers include EXCEVAL (registered trademark, manufactured by KURARAY CO., LTD.) and Nichigo G-Polymer (trade name, manufactured by The Nippon Synthetic Chemical Industry Co., Ltd.). Regarding the polyvinyl alcohol, two or more kinds, which have differences in the degree of polymerization or the kind of modification, can be used in combination.

The weight average molecular weight of the water-soluble polymer is preferably 1,000 to 200,000 and more preferably 3,000 to 40,000. Incidentally, in the present specification, regarding the weight average molecular weight, a value measured using gel permeation chromatography (GPC) under measurement conditions described below is employed.

Solvent: 0.2 M NaNO3, NaH2PO4, pH 7

Column: Combination of Shodex Column Ohpak SB-802.5 HQ, 8×300 mm and Shodex Column Ohpak SB-805 HQ, 8×300 mm

Column temperature: 45° C.

Sample concentration: 0.1% by mass

Detector: RID-10A (manufactured by SHIMADZU CORPORATION)

Pump: LC-20AD (manufactured by SHIMADZU CORPORATION)

Flow rate: 1 ml/min

Calibration curve: A calibration curve based on standard pullulan, Standard P-82 for Shodex Standard GFC (water-based GPC) column, is used.

A curing agent may be used in order to cure a water-soluble polymer.

The curing agent is not particularly limited as long as it induces a curing reaction with a water-soluble polymer; however, in a case where the water-soluble polymer is polyvinyl alcohol, boric acid and a salt thereof are preferable. In addition to them, known curing agents can be used, and the curing agent is generally a compound having a group which is capable of reacting with a water-soluble polymer or a compound that accelerates a reaction between different groups carried by a water-soluble polymer. The curing agent is appropriately selected according to the kind of the water-soluble polymer and used. Specific examples other than boric acid and a salt thereof as the curing agent include epoxy-based curing agents (diglycidyl ethyl ether, ethylene glycol diglycidyl ether, 1,4-butanediol diglycidyl ether, 1,6-diglycidyl cyclohexane, N,N-diglycidyl-4-glycidyloxyaniline, sorbitol polyglycidyl ether, glycerol polyglycidyl ether, and the like), aldehyde-based curing agents (formaldehyde, glyoxal, and the like), active halogen-based curing agents (2,4-dichloro-4-hydroxy-1,3,5-s-triazine and the like), active vinyl-based compounds (1,3,5-tris-acryloyl-hexahydro-s-triazine, bisvinylsulfonyl methyl ether, and the like), and aluminum alum.

In a case where the water-soluble polymer is gelatin, examples of the curing agent include organic hardening agents such as a vinylsulfone compound, a urea-formalin condensate, a melanin-formalin condensate, an epoxy-based compound, an aziridine-based compound, and an active olefin, an isocyanate-based compound, and inorganic polyvalent metal salts of chromium, aluminum, zirconium, and the like.

Incidentally, the form of the copolymer in a case where the polymer is a copolymer may be any of a block copolymer, a random copolymer, a graft copolymer, or an alternating copolymer.

Further, in the high-refractive-index layer or the low-refractive-index layer of the optical reflection film of the present invention, various known additives including ultraviolet absorbers, discoloration inhibitors, various anionic, cationic or nonionic surfactants, fluorescent whitening agents, pH adjusting agents such as sulfuric acid, phosphoric acid, acetic acid, citric acid, sodium hydroxide, potassium hydroxide, and potassium carbonate, defoamants, lubricating agents such as diethylene glycol, antiseptic agents, antistatic agents, and mattifying agents may be contained.

Regarding a suitable embodiment of the reflection unit, it is preferable to use a polymer since an area can be largely increased, the reflection unit is inexpensive in terms of cost, and durability of the film at the time of bending or under high temperature and high humidity conditions is enhanced. In addition to the embodiment in which the reflection unit is composed only of a polymer, an embodiment in which the reflection unit contains a polymer and metal oxide particles is more preferable.

(Method for Producing Reflection Unit)

The reflection unit has a lamination structure in which at least one of the low-refractive-index layer and the high-refractive-index layer is laminated. Specifically, similarly to the method described in U.S. Pat. No. 6,049,419 as described above, in addition to a method of forming a reflection unit by melt extrusion and stretching of a polymer, a method of forming a laminated body by alternately wet applying a water-based coating liquid for a high-refractive-index layer and a coating liquid for a low-refractive-index layer and drying the coating liquids is exemplified.

Regarding the method of alternately wet applying a water-based coating liquid for a high-refractive-index layer and a coating liquid for a low-refractive-index layer, the following coating methods are preferably used. For example, a roll coating method, a rod bar coating method, an air knife coating method, a spray coating method, a curtain coating method, or a slide hopper coating method, an extrusion coating method, and the like described in U.S. Pat. No. 2,761,419, U.S. Pat. No. 2,761,791, and the like are preferably used. Further, a method of multilayer coating of a plurality of layers may be sequential multilayer coating, or may be simultaneous multilayer coating.

Regarding the method of coating and drying, it is preferable to warm the water-based coating liquid for a high-refractive-index layer and the coating liquid for a low-refractive-index layer to 30° C. or higher, then perform the coating, cool the temperature of the coating film thus formed once to 1 to 15° C., and dry the coating film at 10° C. or higher. More preferably, the method of coating and drying is carried out under the drying conditions of a wet bulb temperature of 5 to 50° C. and a film surface temperature in the range of 10 to 50° C. Further, regarding the method of cooling immediately after application, it is preferable to carry out the cooling by a horizontal set method from the viewpoint of the uniformity of the coating film thus formed.

Regarding the viscosity of the coating liquid for a high-refractive-index layer and the coating liquid for a low-refractive-index layer at the time of performing simultaneous multilayer coating, in the case of using a slide hopper coating method, the viscosity is preferably in the range of 5 to 100 mPa·s and more preferably in the range of 10 to 50 mPa·s. Further, in the case of using a curtain coating method, the viscosity is preferably in the range of 5 to 1200 mPa·s and more preferably in the range of 25 to 500 mPa·s.

Further, the viscosity at 15° C. of the coating liquid is preferably 100 mPa·s or more, more preferably 100 to 30,000 mPa·s, even more preferably 3,000 to 30,000 mPa·s, and most preferably 10,000 to 30,000 mPa·s.

Regarding the coating thickness of the coating liquid for a high-refractive-index layer and the coating liquid for a low-refractive-index layer, it is desirable to apply the coating liquids to obtain the preferred thickness at the time of drying as described above.

<Other Function Layers>

In the present invention, the optical reflection film also preferably includes various function layers described below depending on the purpose, in addition to the above-described function layers such as the high-refractive-index layer, the low-refractive-index layer, and the birefringence layer.

(Hard Coat Layer)

In the optical reflection film of the present invention, a hard coat layer can be provided as an outermost layer. The hard coat layer according to the present invention is provided for preventing a scratch.

The hard coat layer according to the present invention can be formed, for example, by an acrylic resin, a urethane-based resin, a melamine-based resin, an epoxy-based resin, an organic silicate compound, a silicon-based resin, or the like as a binder. In particular, in terms of hardness, durability, and the like, a silicon-based resin or an acrylic resin is preferable. Further, in terms of curing properties, flexibility, and productivity, an active energy ray-curable acrylic resin or a thermosetting acrylic resin is preferably employed.

The active energy ray-curable acrylic resin or the thermosetting acrylic resin is a composition that contains multifunctional acrylate, an acrylic oligomer, or a reactive diluent as a polymerization curing component. In addition to them, as necessary, a resin that contains a photoinitiator, a photosensitizer, a thermal polymerization initiator, a modifying agent, or the like may be used.

The acrylic oligomer includes a compound in which a reactive acrylic group is bonded to a skeleton of acrylic resin, polyester acrylate, urethane acrylate, epoxy acrylate, polyether acrylate, or the like, and a compound in which an acrylic group is bonded to a rigid skeleton such as melamine or isocyanuric acid may also be used.

Further, as a medium of a coating agent, the reactive diluent has a function as a solvent in a coating step, and also has a group that reacts with a monofunctional or multifunctional acrylic oligomer by itself and becomes a copolymerization component of a coating film.

Examples of a multifunctional acrylic curable coating material, which is commercially available, may include “DIABEAM series” manufactured by Mitsubishi Rayon Co., Ltd., “Denacol series” manufactured by NAGASE & CO., LTD., “NK Ester series” manufactured by Shin Nakamura Chemical Co., Ltd., “UNIDIC series” manufactured by DIC Corporation, “ARONIX series” manufactured by TOAGOSEI CO., LTD., “BLEMMER series” manufactured by NOF CORPORATION, “KAYARAD series” manufactured by Nippon Kayaku Co., Ltd., and “LIGHT ESTER series” and “LIGHT ACRYLATE series” manufactured by Kyoeisha Chemical Co., Ltd.

In the hard coat layer according to the present invention, various additives can be further blended as necessary within the range not impairing the effect of the present invention. For example, stabilizers such as an antioxidant, a light stabilizer, and an UV absorber, a surfactant, a leveling agent, an antistatic agent, and the like can be used.

Particularly in the event of coating the hard coat layer, the leveling agent is effective for reducing surface irregularities. As the leveling agent, for example, a dimethyl polysiloxane-polyoxyalkylene copolymer (for example, SH190 manufactured by Dow Corning Toray Co., Ltd.) is suitable as a silicone-based leveling agent.

The method of forming the hard coat layer is not particularly limited, and the hard coat layer is preferably formed by a die coater method, a gravure roll coater method, a spin coating method, a spray method, a blade coating method, an air knife coating method, a dip coating method, a wet coating method such as a transfer method, or a dry coating method such as a vapor deposition method.

(Pressure-Sensitive Adhesive Layer)

Regarding the pressure-sensitive adhesive layer, in a case where the present invention is used for window pasting, the pressure-sensitive adhesive layer is disposed on the outermost layer of the optical reflection film in order to paste the optical reflection film to a window glass.

As for a pressure-sensitive adhesive, it is preferable to have durability with respect to ultraviolet rays, and an acrylic pressure-sensitive adhesive or a silicone pressure-sensitive adhesive is preferable. Further, from the viewpoint of adhesion characteristics and cost, an acrylic pressure-sensitive adhesive is preferable. In particular, from the viewpoint of easily controlling a peeling strength, solvent-based and emulsion-based acrylic pressure-sensitive adhesives are preferable, and a solvent-based acrylic pressure-sensitive adhesive is more preferable. In a case where a solution polymerized polymer is used as a solvent-based acrylic pressure-sensitive adhesive, known polymers can be used as a monomer.

The acrylic pressure-sensitive adhesive to be used may be either of solvent-based and emulsion-based pressure-sensitive adhesives, and is preferably a solvent-based pressure-sensitive adhesive since adhesion force and the like are easily increased, and particularly, a solvent-based pressure-sensitive adhesive obtained by solution polymerization is preferable. Examples of a raw material in a case where such a solvent-based pressure-sensitive adhesive is produced by solution polymerization include acrylic acid ester such as ethyl acrylate, butyl acrylate, 2-ethylhexyl acrylate, or ocryl acrylate as a main monomer that forms a skeleton; vinyl acetate, acrylonitrile, styrene, methyl methacrylate, or the like as a comonomer for improving cohesive force; and methacrylic acid, acrylic acid, itaconic acid, hydroxyethyl methacrylate, glycidyl methacrylate, or the like as a functional group-containing monomer for further promoting crosslinking, imparting a stable adhesion force, and retaining a certain degree of adhesion force even in the presence of water. In the pressure-sensitive adhesive layer of the laminated film, since particularly high tackiness is required, a main polymer having a low glass transition temperature (Tg), such as butyl acrylate, is particularly useful.

In this pressure-sensitive adhesive layer, as an additive, for example, a stabilizer, a surfactant, an ultraviolet absorber, a flame retardant, an antistatic agent, an oxidation inhibitor, a thermal stabilizer, a lubricating agent, a filler, a colorant, an adhesiveness adjusting agent, or the like can be contained. In particular, in the case of using the optical reflection film for window pasting as in the case of the present invention, the addition of an ultraviolet absorber is effective, also for suppressing deterioration of the optical reflection film caused by ultraviolet rays.

The thickness of the pressure-sensitive adhesive layer is preferably 1 to 100 μm and more preferably 3 to 50 μm. When the thickness thereof is 1 μm or more, tackiness tends to increase, and sufficient adhesion force is obtained when the optical reflection film is pasted on a substrate. On the contrary, when the thickness thereof is 100 μm or less, not only transparency of the optical reflection film is improved, but also when the optical reflection film is pasted on a window glass, there is a tendency that cohesive failure between pressure-sensitive adhesive layers does not occur and the pressure-sensitive adhesive residue on the glass surface is removed.

As a coating method of the pressure-sensitive adhesive layer, arbitrary known methods can be used, and for example, a die coater method, a gravure roll coater method, a blade coater method, a spray coater method, an air knife coating method, a dip coating method, a transfer method, and the like are preferably exemplified. These methods can be used alone or in combination thereof. According to these methods, coating can be carried out by appropriately using a coating liquid obtained by dissolving a pressure-sensitive adhesive in a solvent, which can dissolve the pressure-sensitive adhesive, to obtain a solution or obtained by dispersing a pressure-sensitive adhesive in the solvent, and a known solvent can be used as a solvent.

The formation of the pressure-sensitive adhesive layer may be carried out by applying a pressure-sensitive adhesive directly to the optical reflection film by the aforementioned coating method, or by applying a pressure-sensitive adhesive to a release film once and drying the release film, and then pasting the obtained film on the optical reflection film so as to transfer the pressure-sensitive adhesive to the optical reflection film. At this time, a drying temperature is preferably set such that the residue solvent is small as much as possible. For achieving this, although a drying temperature or time is not specified, the temperature is preferably set to 50 to 150° C. and the drying time is preferably set to 10 seconds to 5 minutes.

(Adhesive Layer)

The adhesive layer is disposed for pasting the birefringence layer or the reflection unit on the base material or the reflection unit. The same material to be used for the pressure-sensitive adhesive layer can be used as the material for the adhesive layer. The thickness of the adhesive layer is preferably 3 to 50 μm and more preferably 1 to 100 μm. When the thickness thereof is 1 μm or more, the adhesiveness tends to increase, and when the birefringence layer or the reflection unit is pasted on the base material or the reflection unit, sufficient adhesive force is obtained. On the contrary, when the thickness thereof is 100 μm or less, transparency of the optical reflection film is improved and an optical reflection film with favorable light transmittance is obtained.

As the coating method of the adhesive layer, arbitrary known methods can be used, and for example, a die coater method, a gravure roll coater method, a blade coater method, a spray coater method, an air knife coating method, a dip coating method, a transfer method, and the like are preferably exemplified. These methods can be used alone or in combination thereof. According to these methods, coating can be carried out by appropriately using a coating liquid obtained by dissolving a pressure-sensitive adhesive in a solvent, which can dissolve the pressure-sensitive adhesive, to obtain a solution or obtained by dispersing a pressure-sensitive adhesive in the solvent, and a known solvent can be used as a solvent.

As a method of pasting the birefringence layer or the reflection unit on the base material or the reflection unit with the adhesive layer interposed therebetween, arbitrary known methods can be used, and for example, lamination methods such as dry lamination, extrusion lamination, hot melt lamination, wet lamination, wax lamination, and thermal lamination are preferably exemplified.

For the purpose of further providing functions, the optical reflection film of the present invention may have one or more of function layers such as a conductive layer, an antistatic layer, a gas barrier layer, an easy adhesive layer (adhesive layer), an antifouling layer, a deodorant layer, a dripping layer, an easy lubricating layer, an abrasion resistant layer, an antireflection layer, an electromagnetic wave shielding layer, an ultraviolet absorbing layer, an infrared absorbing layer, a printed layer, a fluorescence emitting layer, a hologram layer, a release layer, a pressure-sensitive adhesive layer, an adhesive layer, an infrared cutting layer (metal layer or liquid crystal layer) other than the high-refractive-index layer and the low-refractive-index layer of the present invention, a colored layer (visible light absorbing layer), and an intermediate film layer used for a laminated glass.

As the intermediate film layer used for a laminated glass, a polyvinyl butyral-based resin or an ethylene-vinyl acetate copolymer-based resin may be used. Specific examples thereof include plastic polyvinyl butyrals [manufactured by Sekisui Chemical Co., Ltd., manufactured by Mitsubishi Monsanto Chemical Company, and the like], ethylene-vinyl acetate copolymers [manufactured by Du Pont and Duramin manufactured by Takeda Pharmaceutical Company Limited], and modified ethylene-vinyl acetate copolymers [Melthene G manufactured by Tosoh Corporation]. Incidentally, an ultraviolet absorber, an oxidation inhibitor, an antistatic agent, a thermal stabilizer, a lubricating agent, a filler, a colorant, an adhesiveness adjusting agent, or the like may be suitably added and blended in the adhesive layer.

The lamination order of various function layers described above in the optical reflection film is not particularly limited.

For example, in a specification in which the optical reflection film of the present invention is pasted on the indoor side of the window glass (indoor pasting), an aspect in which a reflection unit including at least one unit obtained by laminating the high-refractive-index layer and the low-refractive-index layer, and a pressure-sensitive adhesive layer are laminated in this order on the surface of the base material, and a hard coat layer is further formed by coating on the surface of the base material opposite to the side on which these layers are laminated, is exemplified as a preferred example. Further, the lamination order of the pressure-sensitive adhesive layer, the base material, the reflection unit, and the hard coat layer may be applicable, or other function layers, the base material, an infrared absorbing agent, or the like may be further included. In addition, in a specification in which the optical reflection film of the present invention is pasted on the outdoor side of the window glass (outdoor pasting), a configuration in which the reflection unit and the pressure-sensitive adhesive layer are laminated in this order on the surface of the base material, and a hard coat layer is further formed by coating on the surface of the base material opposite to the side on which these layers are laminated is exemplified as a preferred example. Similar to the case of indoor pasting, the lamination order of the pressure-sensitive adhesive layer, the base material, the reflection unit, and the hard coat layer may be applicable, or other function layer base materials, an infrared absorbing agent, or the like may be further included.

<Base Material>

The base material to be used in the present invention is provided for supporting the optical reflection film and various resin films can be used as the base material. As specific examples thereof, polyolefin films (polyethylene, polypropylene, and the like), polyester films (polyethylene terephthalate, polyethylene naphthalate, and the like), polyvinyl chloride, cellulose triacetate, and the like can be used, and polyester films are preferable. There are no particular limitations on the polyester film; however, a polyester containing a dicarboxylic acid component and a diol component as main constituent components and having film formability is preferable. Examples of the dicarboxylic acid component of the main constituent component may include terephthalic acid, isophthalic acid, phthalic acid, 2,6-naphthalenedicarboxylic acid, 2,7-naphthalenedicarboxylic acid, diphenylsulfonedicarboxylic acid, diphenyl ether dicarboxylic acid, diphenylethane dicarboxylic acid, cyclohexanedicarboxylic acid, diphenyldicarboxylic acid, diphenyl thioether dicarboxylic acid, diphenyl ketone dicarboxylic acid, and phenylindane dicarboxylic acid. Further, examples of the diol component may include ethylene glycol, propylene glycol, tetramethylene glycol, cyclohexanedimethanol, 2,2-bis(4-hydroxyphenyl)propane, 2,2-bis(4-hydroxyethoxyphenyl)propane, bis(4-hydroxyphenyl)sulfone, bisphenolfluorene dihydroxyethyl ether, diethylene glycol, neopentyl glycol, hydroquinone, and cyclohexanediol. Among the polyesters containing these components as the main constituent components, from the viewpoint of transparency, mechanical strength, dimensional stability, and the like, polyesters containing terephthalic acid or 2,6-naphthalenedicarboxylic acid (as a dicarboxylic acid component) and ethylene glycol or 1,4-cyclohexanedimethanol (as a diol component) as the main constituent components are preferable. Among them, polyesters containing polyethylene terephthalate or polyethylene naphthalate as a main constituent component, copolymerized polyesters consisting of terephthalic acid, 2,6-naphthalenedicarboxylic acid, and ethylene glycol, and polyesters containing mixtures of two or more kinds of these polyesters as the main constituent components are preferable.

The thickness of the base material to be used in the present invention is preferably 10 to 300 μm and particularly preferably 20 to 150 μm. Further, the base material of the present invention may be formed from two sheets superposed together, and in this case, the kinds of the sheets may be identical or may be different.

Further, the base material to be used in the present invention is not particularly limited as long as mechanical strength for supporting the film, light transmittance, and dimensional stability can be obtained, and in addition to various resin films described above, other constituent layers such as a birefringence layer can be used as the base material.

The base material using a resin film can be produced by a general method that is conventionally known. For example, an unstretched base material that is substantially amorphous and non-oriented can be produced by melting a resin to be used as a material with an extruder, and rapidly cooling the resin by extruding the resin with an annular die or a T-die. Further, a stretched support can be produced by stretching an unstretched base material by a known method such as uniaxial stretching, tenter type sequential biaxial stretching, tenter type simultaneous biaxial stretching, or tubular type simultaneous biaxial stretching, in the flow (longitudinal axis) direction of the base material or in a direction perpendicular to the flow direction of the base material (transverse axis direction). In this case, the stretching ratio can be appropriately selected in accordance with the resin that is used as the raw material of the base material, but the stretching ratio is preferably 2 to 10 times in the longitudinal axis direction and the transverse axis direction, respectively.

<<Application of Optical Reflection Film: Optical Reflection Body>>

The optical reflection film provided by the present invention is applicable to broad fields. For example, the optical reflection film of the present invention is suitably used for a film for pasting the optical reflection film on a window such as an outdoor window of buildings or a window of vehicles, a film for agricultural vinyl greenhouses, or the like.

In particular, the optical reflection film according to the present invention is suitable as an optical reflection film to be used by pasting the optical reflection film directly or with a pressure-sensitive adhesive layer interposed therebetween on a glass or a substrate, in place of a glass, such as a resin.

In other words, according to another embodiment of the present invention, an optical reflection body in which the optical reflection film according to the present invention is provided on at least one surface of the substrate is also provided.

Specific examples of the substrate on which the optical reflection film of the present invention is pasted include a glass, a resin film or resin substrate such as a polycarbonate resin, a polysulfone resin, an acrylic resin, a polyolefin resin, a polyether resin, a polyester resin, a polyamide resin, a polysulfide resin, an unsaturated polyester resin, an epoxy resin, a melamine resin, a phenol resin, a diallyl phthalate resin, a polyimide resin, a urethane resin, a polyvinyl acetate resin, a polyvinyl alcohol resin, a styrene resin, or a vinyl chloride resin, a metal plate, and ceramic. The type of resins may be any one of a thermoplastic resin, a thermosetting resin, and an ionizing radiation curing resin, and may be used in combination of two or more kinds thereof. The substrate can be produced by a known method such as extrusion molding, calendar molding, injection molding, hollow molding, or compression molding. The thickness of the substrate is not particularly limited, and is generally 0.1 mm to 5 cm.

When the optical reflection film is pasted on the substrate, the pressure-sensitive adhesive layer is preferably disposed at a sunlight (heat ray) incident side of the optical reflection film. Further, when the optical reflection film is sandwiched between the window glass and the substrate, the optical reflection film can be sealed from environment gas such as moisture, and thus is excellent in durability, which is preferable. The disposition of the optical reflection film according to present invention at the outdoor side or the outside (for outdoor pasting) of vehicles is also preferable to enhance the durability against environment.

The heat insulating performance and solar heat shielding performance of an optical reflection film or an infrared shielding body can be generally obtained by methods based on JIS R 3209 (1998) (Sealed insulating glass), JIS R 3106 (1998) (Testing method on transmittance, reflectance and emittance of flat glasses and evaluation of solar heat gain coefficient), and JIS R 3107 (1998) (Evaluation on thermal resistance of flat glasses and thermal transmittance of glazing).

Regarding the measurement of solar transmittance, solar reflectance, emissivity, and visible light transmittance, (1) spectrophotometric transmittance and spectrophotometric reflectance of various single flat glasses are measured using a spectrophotometric light measuring device (a wavelength of 300 to 2500 nm). Further, by using a spectrophotometric light measuring device with a wavelength of 5.5 to 50 μm, the emissivity is measured. Incidentally, as for the emissivity of a float plate glass, a polished plate glass, a template plate glass, and a heat ray-absorbing plate glass, previously determined values are used. (2) Regarding calculation of solar transmittance, solar reflectance, solar absorbance, and corrected emissivity, solar transmittance, solar reflectance, solar absorbance, and normal emissivity are calculated according to JIS R 3106 (1998). The corrected emissivity is obtained by multiplying the normal emissivity by a coefficient described in JIS R 3107 (1998). For calculation of the heat insulating property and solar heat shielding property, (1) thermal resistance of a sealed insulating glass is calculated according to JIS R 3209 (1998) by using the measured thickness value and corrected emissivity. However, when a hollow layer is more than 2 mm, the gas heat conductance of the hollow layer is obtained according to JIS R 3107 (1998). (2) The heat insulating property is obtained as heat transmission resistance by adding the heat transfer resistance to the thermal resistance of the sealed insulating glass. (3) The solar heat shielding property is calculated by obtaining a solar heat gain coefficient according to JIS R 3106 (1998) and subtracting the result from 1.

### EXAMPLES

Hereinafter, the description will be given of examples by which the effect of the present invention was confirmed. Incidentally, the present invention is not limited to these examples.

<Production of Optical Reflection Film>

(Preparation of Coating Liquid for High-Refractive-Index Layer)

First, 28.9 parts of 20.0% by mass water-based dispersion liquid of titanium oxide sol containing rutile-type titanium oxide fine particles (volume average particle diameter: 10 nm), 5.41 parts of 14.8% by mass aqueous solution of picolinic acid, and 3.92 parts of 2.1% by mass aqueous solution of lithium hydroxide were mixed to prepare a titanium oxide dispersion liquid H1.

Subsequently, to 10.3 parts of pure water, 130 parts of 1.0% by mass aqueous solution of tamarind seed gum as thickening polysaccharides, 10.3 parts of 5.0% by mass polyvinyl alcohol (PVA217, manufactured by KURARAY CO., LTD.), 17.3 parts of 14.8% by mass aqueous solution of picolinic acid, and 2.58 parts of 5.5% by mass aqueous solution of boric acid were sequentially added under stirring. Thereto, 38.2 parts of the titanium oxide dispersion liquid H1 obtained above was added. Thereafter, 0.050 part of 5% by mass quaternary ammonium-based cationic surfactant (Nissan Cation-2-DB-500E manufactured by NOF Corporation) was added as a surfactant. Pure water was added to prepare total 223 parts of a coating liquid H1 for a high-refractive-index layer.

(Preparation of Coating Liquid for Low-Refractive-Index Layer)

First, 21 parts of 23.5% by mass aqueous solution of aluminum polychloride (TAKIBINE #1500, manufactured by Taki Chemical Co., Ltd.), 550 parts of 10% by mass aqueous solution of colloidal silica (SNOWTEX OXS, manufactured by Nissan Chemical Industries, Ltd.), 61 parts of 3.0% by mass aqueous solution of boric acid, and 4.75 parts of 2.1% by mass aqueous solution of lithium hydroxide were mixed and dispersed using a high pressure homogenizer disperser. Thereafter, pure water was added to prepare total 1000 parts of silicon oxide dispersion liquid L1.

Subsequently, the obtained dispersion liquid L1 was heated to 45° C., and 100 parts of pure water and 575 parts of 4.0% by mass aqueous solution of polyvinyl alcohol (PVA235, manufactured by KURARAY CO., LTD.) were added thereto under stirring. Thereafter, 0.50 part of 5% by mass quaternary ammonium-based cationic surfactant (Nissan Cation-2-DB-500E manufactured by NOF Corporation) was added as a surfactant to prepare a coating liquid L1 for a low-refractive-index layer.

(Preparation of Pressure-Sensitive Adhesive Solution)

A pressure-sensitive adhesive solution was prepared by allowing 10.0% by mass of polyvinyl acetal resin to be contained in an ethanol solution (BX-L, acetalization rate: 61 mol %, manufactured by SEKISUI CHEMICAL CO., LTD.).

(Preparation of Hard Coat Liquid)

A coating liquid for a hard coat layer was prepared in such a manner that 73 parts of pentaerythritol tri/tetraacrylate (NK Ester A-TMM-3, manufactured by Shin Nakamura Chemical Co., Ltd.), 5 parts of IRGACURE 184 (manufactured by BASF Japan Ltd.), 1 part of silicone-based surfactant (KF-351A, manufactured by Shin-Etsu Chemical Co., Ltd.), 10 parts of propylene glycol monomethyl ether, 70 parts of methyl acetate, and 70 parts of methyl ethyl ketone were mixed, and the obtained liquid mixture was filtered through a polypropylene filter having a pore size of 0.4 μm.

(Production of Birefringence Layer)

A resin obtained by melting polyethylene terephthalate (PET) was casted on a cooling drum with a surface temperature of 30° C. so that the resin was brought into close contact with the surface of the cooling drum by using an electrostatic charging method to be cooled and solidified. Thereafter, the temperature of the film was increased to 75° C. by a roll group heated to 78° C., was heated to 105° C. by an infrared heater, and was then stretched by 2.8 times in the longitudinal direction by the roll group having different circumferential speeds. The obtained uniaxially stretched film was gripped by clips and stretched by 4.5 times at 120° C. in the width direction by a tenter. Subsequently, thermal treatment was carried out at 210° C. for 15 seconds, end portions in the region of 0 to 15% and the region of 85 to 100% in the width direction of a mill roll were slit to thereby obtain a PET film A having a thickness of 50 μm. Further, PET films B to F each having an in-plane retardation presented in Table 1 were formed by appropriately setting the thickness of the birefringence layer.

TABLE 1

| | Thickness | In-plane retardation |
|---|---|---|
| PET film | (μm) | (nm) |
| PET film A | 50 | 3000 |
| PET film B | 90 | 5500 |
| PET film C | 175 | 10500 |
| PET film D | 130 | 8400 |
| PET film E | 25 | 1800 |
| PET film F | 40 | 2500 |

### Example 1-1

The layer configuration of an optical reflection film in the Example 1-1 was illustrated in FIG. 2A.

Simultaneous multilayer coating of 22 layers in total was carried out using a slide hopper coating apparatus such that while the coating liquid for a low-refractive-index layer and the coating liquid for a high-refractive-index layer obtained above were kept warm at 45° C., low-refractive-index layers and high-refractive-index layers were formed on the base material 5 of a polyethylene terephthalate film (A4300 manufactured by TOYOBO CO., LTD.: double-sided easy adhesive layer, 200 m in length×210 mm in width) having a thickness of 50 μm and heated to 45° C. with both outermost layers being low-refractive-index layers, while other layers being alternately laminated, and the film thickness upon drying was 150 nm for each of the low-refractive-index layers and 130 nm for each of the high-refractive-index layers. Incidentally, regarding the confirmation of a mixed region between layers (mixed layer) and the measurement (confirmation) of the film thickness, a laminated film (optical reflection film sample) was cut, and the cut surface was analyzed with an XPS surface analyzer to measure the amounts of existence of the high-refractive-index material (TiO₂) and the low-refractive-index material (SiO₂). Thereby, it could be confirmed that the above-described thicknesses of the respective layers were secured.

Immediately after coating, the layers were set by blowing cold air at 5° C. At this time, the time period until nothing stuck to a finger even after the surface was touched by the finger (setting time) was 5 minutes. After the completion of the setting, the layers were dried by blowing hot air at 80° C. to form the reflection unit 4a on a base material.

The reflection unit 4b was formed on the surface, on which the reflection unit 4a was formed, of the base material 5 in the same manner as in the reflection unit 4a.

The hard coat liquid was applied to the surface opposite to the surface, which came into contact with the base material 5, of the reflection unit 4a by using a microgravure coater, and the hard coat liquid was dried at a constant rate drying zone temperature of 50° C. and a decreasing rate drying zone temperature of 90° C. Thereafter, the coating layer was cured using an ultraviolet lamp at an illuminance of an irradiation unit of 100 mW/cm² and an amount of irradiation of 0.2 J/cm², and thus the hard coat layer 6 was formed so as to have a dried film thickness of 6 μm.

The pressure-sensitive adhesive solution was applied to the surface opposite to the surface, which came into contact with the base material 5, of the reflection unit 4b at such a coating amount that the film thickness after drying became 3 μm, and dried at 70° C. Thereby, the adhesive layer 12 was formed.

The PET film A was pasted as the birefringence layer 3 on the adhesive layer 12 by a lamination method, the pressure-sensitive adhesive solution was applied to the surface of the birefringence layer 3 at such a coating amount that the film thickness after drying became 10 μm and dried at 70° C., and thus the pressure-sensitive adhesive layer 2 was formed. Thereby, an optical reflection film a-1 was produced.

### Example 1-2

An optical reflection film a-2 was produced in the same conditions as in Example 1-1, except that the birefringence layer was changed to a PET film B.

### Example 1-3

An optical reflection film a-3 was produced in the same conditions as in Example 1-1, except that the birefringence layer was changed to a PET film C.

### Example 1-4

An optical reflection film a-4 was produced in the same conditions as in Example 1-1, except that the birefringence layer was changed to a PET film D.

### Comparative Example 1-5

An optical reflection film a-5 in which the hard coat layer 6, the reflection unit 4a, the base material 5, the reflection unit 4b, and the pressure-sensitive adhesive layer 2 were laminated in this order was produced in the same conditions as in Example 1-1, except that the birefringence layer was not disposed.

### Comparative Example 1-6

An optical reflection film a-6 was produced in the same conditions as in Example 1-1, except that the birefringence layer was changed to a PET film E.

### Comparative Example 1-7

An optical reflection film a-7 was produced in the same conditions as in Example 1-1, except that the birefringence layer was changed to a PET film F.

### Example 2

The layer configuration of an optical reflection film in Example 2 was illustrated in FIG. 2B. In Example 2, the reflection unit 4a or the reflection unit 4b was formed on each surface of the base material 5 by simultaneous multilayer coating under the same conditions as in Example 1-1. Then, the pressure-sensitive adhesive layer 2 having a film thickness of 10 μm was formed by coating on the surface opposite of the surface, which came into contact with the base material 5, of the reflection unit 4b. Further, the PET film D was pasted as the birefringence layer 3 on the surface opposite to the surface, which came into contact with the base material 5, of the reflection unit 4a with the adhesive layer 12 having a film thickness of 3 μm interposed therebetween. The hard coat layer 6 having a film thickness of 6 μm was formed on the surface of the PET film D under the same conditions as in Example 1-1 to thereby produce an optical reflection film b.

### Example 3

The layer configuration of an optical reflection film in Example 3 was illustrated in FIG. 2C. In Example 3, the PET film D was used as the birefringence layer 3. The reflection unit 4b and the reflection unit 4a were respectively formed on the surface of the birefringence layer 3 and the surface of the base material 5 by simultaneous multilayer coating under the same conditions as in Example 1-1. An adhesive layer having a film thickness of 3 μm was formed on the surface, on which the reflection unit 4a was not formed, of the base material under the same conditions as in Example 1-1 and was pasted on the birefringence layer 3, and a pressure-sensitive adhesive layer having a film thickness of 10 μm and a hard coat layer having a film thickness of 6 μm were respectively formed on the surface of the reflection unit 4b and the surface of the reflection unit 2 under the same conditions as in Example 1-1 to thereby produce an optical reflection film c.

### Example 4

The layer configuration of an optical reflection film in Example 4 was illustrated in FIG. 2D. In Example 4, the PET film D was used as the birefringence layer 3. The reflection unit 4b, the birefringence layer 3, the adhesive layer 12 having a film thickness of 3 μm, the base material 5, and the reflection unit 4a were laminated under the same conditions as in Example 3, and the hard coat layer 6 and a pressure-sensitive adhesive layer having a film thickness of 10 μm were respectively formed on the surface of the reflection unit 4b and the surface of the reflection unit 4a under the same conditions as in Example 1-1 to thereby produce an optical reflection film d.

### Example 5-1

The layer configuration of an optical reflection film in Example 5-1 was illustrated in FIG. 3A. In Example 5-1, the PET film B was used as the birefringence layer 3. The reflection unit 4 was formed on the surface of the birefringence layer 3 by simultaneous multilayer coating under the same conditions as in Example 1-1, the hard coat layer 6 having a film thickness of 6 μm and the pressure-sensitive adhesive layer 2 having a film thickness of 10 μm were respectively formed on the formed reflection unit 4 and the birefringence layer 3 under the same conditions as in Example 1-1 to thereby produce an optical reflection film e-1.

### Example 5-2

The layer configuration of an optical reflection film in Example 5-2 was illustrated in FIG. 3B. In Example 5-2, the PET film B was used as the birefringence layer 3. The reflection unit 4 was formed on the surface of the birefringence layer 3 by simultaneous multilayer coating under the same conditions as in Example 1-1, and the pressure-sensitive adhesive layer 2 having a film thickness of 10 μm and the hard coat layer 6 having a film thickness of 6 μm were respectively formed on the formed reflection unit 4 and the birefringence layer 3 under the same conditions as in Example 1-1 to thereby produce an optical reflection film e-2.

### Example 5-3

The layer configuration of an optical reflection film in Example 5-3 was illustrated in FIG. 3C. In Example 5-3, the PET film B was used as a birefringence layer 3-1 and a birefringence layer 3-2. The reflection unit 4b and the reflection unit 4a were respectively formed on the birefringence layer 3-1 and the birefringence layer 3-2 by simultaneous multilayer coating under the same conditions as in Example 1-1, and the birefringence layer 3-2 and the reflection unit 4b were pasted to each other with the adhesive layer 12 interposed therebetween. Then, the hard coat layer 6 having a film thickness of 6 μm and the pressure-sensitive adhesive layer 2 having a film thickness of 10 μm were respectively formed on the reflection unit 4a and the birefringence layer 3-1 under the same conditions as in Example 1-1 to thereby produce an optical reflection film e-3.

<Measurement of Birefringence Index>

The in-plane retardation of each of the produced PET films A to F was measured by using an automatic birefringence analyzer KOBRA-21ADH (manufactured by Oji Scientific Instruments Co., Ltd.). Under the environment of 23° C. and 55% RH, three-dimensional birefringence index measurement was conducted in a wavelength of 550 nm at an interval of 1 cm in the width direction of the sample, and the measured value was substituted into Equation (1) to obtain an in-plane retardation.

<Evaluation of Iridescent Irregularities>

The surface, on which the pressure-sensitive adhesive layer was formed, of each of the produced optical reflection film was pasted on a glass with water, and with irradiation of a strong white light source from the surface of the hard coat layer of the optical reflection film, existence of iridescent irregularities occurring due to transmitted light was checked by visual inspection from the glass surface (observation direction 10-1). The evaluation of iridescent irregularities was carried out according to the following criteria.

⊙: No occurrence of iridescent irregularities was not recognized.

◯: Very weak iridescent irregularities were recognized, but there was no problem in practical.

X: Iridescent irregularities were definitely recognized, and there is a problem in practical.

The results thus obtained are presented in Table 2.

<Evaluation of Near-Infrared Reflection Performance>

The reflectance of each optical reflection film in a region of 300 nm to 2000 nm was measured by using a spectrophotometer (an integrating sphere was used, manufactured by Hitachi Ltd., U-4000 type), and the value of the reflectance at a near-infrared reflectance of 1100 nm was used. The evaluation of the near-infrared reflection performance was carried out according to the following criteria.

⊙: The near-infrared reflectance was 90% or more.

◯: The near-infrared reflectance was 85 to 89%.

X: The near-infrared reflectance was 84% or less.

TABLE 2

| | | | Near- | |
|---|---|---|---|---|
| Optical | In-plane | Evaluation | infrared | |
| reflection | retardation | of iridescent | reflection | |
| film | (nm) | irregularities | performance | Remark |
| a-1 | 3000 | ◯ | ⊙ | Present invention |
| a-2 | 5500 | ⊙ | ⊙ | Present invention |
| a-3 | 10500 | ⊙ | ⊙ | Present invention |
| a-4 | 8400 | ⊙ | ⊙ | Present invention |
| a-5 | None | X | ⊙ | Comparative |
| | | | | example |
| a-6 | 1800 | X | ⊙ | Comparative |
| | | | | example |
| a-7 | 2500 | X | ⊙ | Comparative |
| | | | | example |
| b | 8400 | ◯ | ⊙ | Present invention |
| c | 8400 | ◯ | ⊙ | Present invention |
| d | 8400 | ◯ | ⊙ | Present invention |
| e-1 | 5500 | ⊙ | ⊙ | Present invention |
| e-2 | 5500 | ◯ | ⊙ | Present invention |
| e-3 | 5500 | ⊙ | ⊙ | Present invention |

From the above Table 2, as compared to Comparative Example a-5 not including the birefringence layer and Comparative Examples a-6 and a-7 in which the in-plane retardation of the birefringence layer was smaller than 3000 nm, in the optical reflection films a-1 to a-4 and b to e-3 of the present invention including the birefringence layer having an in-plane retardation of 3000 nm or more, it was confirmed that occurrence of iridescent irregularities was suppressed. Thus, the effectiveness of the present invention was confirmed.

In the optical reflection films a-2 to a-4, e-1, and e-3 in which the in-plane retardation of the birefringence layer in the optical reflection film was 3000 nm or more and the birefringence layer was disposed between the outermost layer (pressure-sensitive adhesive layer) of the optical reflection film at the observation direction 10-1 side in which iridescent irregularities were observed and the reflection unit disposed closest to the outermost layer, occurrence of iridescent irregularities was not recognized and a high effect of suppressing iridescent irregularities was confirmed.

Next, the surface, on which the pressure-sensitive adhesive layer was formed, of each optical reflection film was pasted on a glass with water, and with irradiation of a strong white light source from the surface of the hard coat layer (observation direction 10-2) of the optical reflection film or the glass surface (observation direction 10-1), the existence of iridescent irregularities occurring due to transmitted light was checked by visual inspection from the direction opposite to the light source through the optical reflection film, and then the evaluation of iridescent irregularities was carried out.

TABLE 3

| | | Evaluation | Evaluation | |
|---|---|---|---|---|
| | | of iridescent | of iridescent | |
| Optical | In-plane | irregularities | irregularities | |
| reflection | retardation | from glass | from hard coat | |
| film | (nm) | side | layer side | Remark |
| b | 8400 | ◯ | ⊙ | Present invention |
| e-1 | 5500 | ⊙ | ◯ | Present invention |
| e-2 | 5500 | ◯ | ⊙ | Present invention |
| e-3 | 5500 | ⊙ | ⊙ | Present invention |

From the above Table 3, it was confirmed that in the optical reflection films b and e-1 to e-3 of the present invention, the occurrence of iridescent irregularities was suppressed in the acceptable range in practical regardless of the check direction of iridescent irregularities, and thus the effectiveness of the present invention was confirmed.

Further, in a case where the birefringence layer was disposed between the outermost layer of the optical reflection film at the side in which iridescent irregularities were checked and the reflection unit disposed closest to the outermost layer, a high effect of suppressing iridescent irregularities was confirmed. For this reason, in the case of buildings, iridescent irregularities are problematic when observation is carried out from the indoor, and thus in the case of indoor pasting, the configuration in which the birefringence layer is disposed between the hard coat layer and the reflection unit is preferable; on the other hand, in the case of outdoor pasting, the configuration in which the birefringence layer is disposed between the pressure-sensitive adhesive layer and the reflection unit is preferable. In the case of vehicles, iridescent irregularities are problematic when observation is carried out from the outside of the vehicles, and thus in the case of indoor pasting, the configuration in which the birefringence layer is disposed between the hard coat layer and the reflection unit is preferable.

### INDUSTRIAL APPLICABILITY

According to the present invention, it is possible to obtain an optical reflection film which is suppressed in iridescent irregularities and has excellent optical reflection performance and light transmittance, and the optical reflection film is applicable to a field of a heat-ray shielding film to be pasted on a building or a vehicle.

### REFERENCE SIGNS LIST

1a Optical reflection film
1b Optical reflection film
2 Pressure-sensitive adhesive layer
3 Birefringence layer
3-1 Birefringence layer
3-2 Birefringence layer
4 Reflection unit
4a Reflection unit
4b Reflection unit
5 Base material
6 Hard coat layer
7 Substrate
10-1 Observation direction
10-2 Observation direction
12 Adhesive layer

1. An optical reflection film having a plurality of function layers, comprising at least:
a reflection unit that is obtained by alternately laminating a high-refractive-index layer and a low-refractive-index layer and reflects light; and
a birefringence layer that has an in-plane retardation of 3000 nm or more.

2. The optical reflection film according to claim 1, wherein the birefringence layer is disposed between an outermost layer and the reflection unit of the optical reflection film.

3. The optical reflection film according to claim 1, wherein two or more reflection units are provided, and the birefringence layer is disposed between the outermost layer and the reflection unit that is the closest to the outermost layer.

4. The optical reflection film according to claim 1, wherein two or more reflection units are provided, and the birefringence layer is disposed between two reflection units.

5. The optical reflection film according to claim 1, wherein the birefringence layer is disposed to come into contact with at least one surface of the reflection unit.

6. The optical reflection film according to claim 1, wherein the birefringence layer is disposed on at least one surface of the reflection unit with an adhesive layer interposed therebetween.

7. An optical reflection film being pasted on an indoor side of a window glass of a building, comprising:
a reflection unit that is obtained by alternately laminating a high-refractive-index layer and a low-refractive-index layer and reflects light; and
a birefringence layer that has an in-plane retardation of 3000 nm or more, wherein
the birefringence layer is disposed between the reflection unit and an outermost layer opposite to a surface, which faces the window glass, of the optical reflection film.

8. An optical reflection film being pasted on a vehicle interior side of a window glass of a vehicle, comprising:
a reflection unit that is obtained by alternately laminating a high-refractive-index layer and a low-refractive-index layer and reflects light; and
a birefringence layer that has an in-plane retardation of 3000 nm or more, wherein
the birefringence layer is disposed between the reflection unit and an outermost layer, which comes into contact with the window glass, of the optical reflection film.

9. The optical reflection film according to claim 2, wherein two or more reflection units are provided, and the birefringence layer is disposed between the outermost layer and the reflection unit that is the closest to the outermost layer.

10. The optical reflection film according to claim 2, wherein two or more reflection units are provided, and the birefringence layer is disposed between two reflection units.

11. The optical reflection film according to claim 2, wherein the birefringence layer is disposed to come into contact with at least one surface of the reflection unit.

12. The optical reflection film according to claim 2, wherein the birefringence layer is disposed on at least one surface of the reflection unit with an adhesive layer interposed therebetween.

13. The optical reflection film according to claim 3, wherein two or more reflection units are provided, and the birefringence layer is disposed between two reflection units.

14. The optical reflection film according to claim 3, wherein the birefringence layer is disposed to come into contact with at least one surface of the reflection unit.

15. The optical reflection film according to claim 3, wherein the birefringence layer is disposed on at least one surface of the reflection unit with an adhesive layer interposed therebetween.

16. The optical reflection film according to claim 4, wherein the birefringence layer is disposed to come into contact with at least one surface of the reflection unit.

17. The optical reflection film according to claim 4, wherein the birefringence layer is disposed on at least one surface of the reflection unit with an adhesive layer interposed therebetween.

18. The optical reflection film according to claim 5, wherein the birefringence layer is disposed on at least one surface of the reflection unit with an adhesive layer interposed therebetween.
